(19) United States
(12) Patent Application Publication
(10) Pub. No.: US 2024/0240966 A1
(43) Pub. Date: Jul. 18, 2024

(54) INFORMATION PROVIDING DEVICE AND INFORMATION PROVIDING METHOD

(71) Applicant: TOYOTA JIDOSHA KABUSHIKI KAISHA, Aichi-ken (JP)

(72) Inventors: Masami AGA, Susono-shi (JP); Masumi TERAYAMA, Fuji-shi (JP); Yoshiaki IRIE, Chiryu-shi (JP)

(21) Appl. No.: 18/510,651

(22) Filed: Nov. 16, 2023

(30) Foreign Application Priority Data
Jan. 16, 2023 (JP) 2023-004547

(51) Int. Cl. G01C 21/00

(52) U.S. Cl. CPC G01C 21/3885; G01C 21/3841; G01C 21/3881

(57) ABSTRACT

The information providing device includes a communication unit capable of communicating with a plurality of vehicles, a storage unit configured to store a distribution of vehicle speeds corresponding to a traveling direction in each of an automobile dedicated road and a general road on each of map tiles, and a processor configured to transmit, to a target vehicle among the plurality of vehicles, information of the distribution for a map tile including a current position of the target vehicle.

### FIELD

The present disclosure relates to an information providing device and an information providing method.

### BACKGROUND

Patent Literature 1 discloses a road type determination method capable of accurately determining which road the vehicle is traveling on, even if the general road and the automobile dedicated road are close to each other. In such a method, the type of road is determined by determining whether the stop position of the vehicle is near the installation location of the traffic light, or whether the vehicle has decelerated near the exit of the automobile dedicated road. CITATIONS LIST

### PATENT LITERATURE

[PTL 1] Japanese Unexamined Patent Publication No. 2001-349734

### SUMMARY

### Technical Problem

However, in the above-described method, it is assumed that the vehicle knows an accurate position of a traffic light or the like, that is, the vehicle has map information. Therefore, such a method cannot be applied to a vehicle having no map information.

In view of the above problems, an object of the present disclosure is to assist a vehicle having no map information in identifying a type of a road on which the vehicle is traveling.

### Solution to Problem

The summary of the present disclosure is as follows.

(1) An information providing device comprising: a communication unit capable of communicating with a plurality of vehicles; a storage unit configured to store a distribution of vehicle speeds corresponding to a traveling direction in each of an automobile dedicated road and a general road on each of map tiles; and a processor configured to transmit, to a target vehicle among the plurality of vehicles, information of the distribution for a map tile including a current position of the target vehicle.

(2) The information providing device described in above (1), wherein the processor is configured to create the distribution based on data transmitted from a probing vehicle among the plurality of vehicles.

(3) The information providing device described in above (1) or (2), wherein the storage unit is configured to store position information of an incident that has occurred on a road, and the processor is configured to transmit the position information of the incident to the target vehicle in addition to the information of the distribution.

(4) The information providing device described in above (3), wherein the processor is configured to identify a target vehicle located on a map tile in which the incident has occurred, and transmit the information of the distribution and the position information of the incident to the target vehicle.

(5) A method of providing information, comprising: storing a distribution of vehicle speeds corresponding to a travel direction in each of an automobile dedicated road and a general road on each of map tiles; and transmitting, to a target vehicle, information of the distribution for a map tile including a current position of the target vehicle.

According to the present disclosure, it is possible to assist a vehicle having no map information in identifying a type of a road on which the vehicle is traveling.

### BRIEF DESCRIPTION OF DRAWINGS

FIG. 1 is a schematic configuration diagram of an information providing system according to an embodiment of the present disclosure.

FIG. 2 is a diagram illustrating an example of a configuration of a vehicle.

FIG. 3 is a functional block diagram of a processor of the server.

FIG. 4 is a flowchart showing a control routine executed in the probing vehicle.

FIG. 5 is a flowchart showing a control routine executed in the server.

FIG. 6 is a flowchart showing a control routine executed in the target vehicle.

FIG. 7 is a diagram illustrating an example of a velocity distribution.

### DESCRIPTION OF EMBODIMENTS

Hereinafter, embodiments of the present disclosure will be described in detail with reference to the drawings. In the following description, the same reference numerals are given to the same constituent elements.

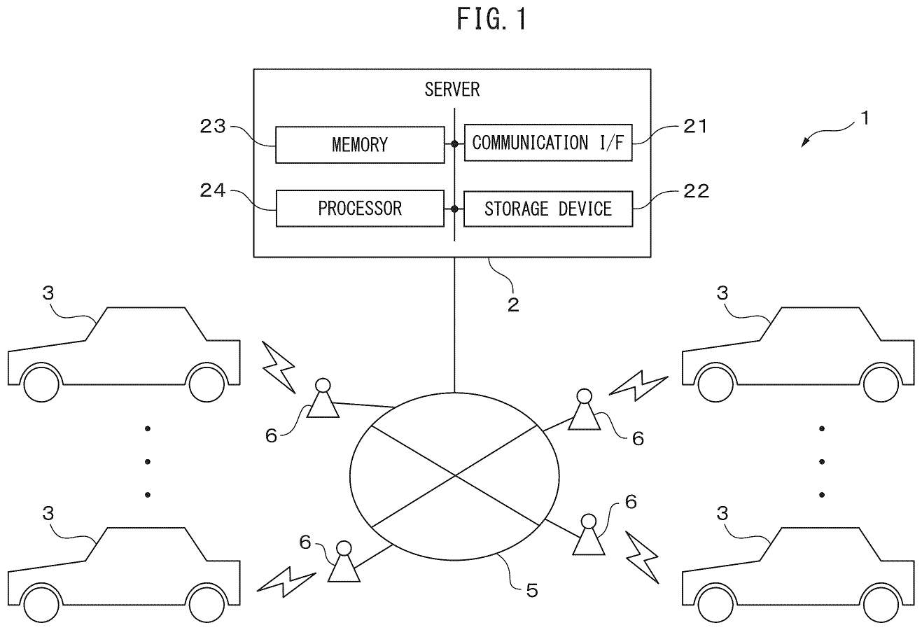

FIG. 1 is a schematic configuration diagram of an information providing system 1 according to an embodiment of the present disclosure. As shown in FIG. 1, the information providing system 1 includes a server 2 and a plurality of vehicles 3. The server 2 is capable of communicating with each of the plurality of vehicles 3 via a communication network 5, such as an Internet network, and a radio base station 6 connected to the communication network 5. The communication between the vehicles 3 and the radio base stations 6 is performed by a known radio communication technique (for example, 3G, LTE, 4G, 5G or the like).

As shown in FIG. 1, the servers 2 are provided outside the plurality of vehicles 3, and include a communication interface 21, a storage device 22, a memory 23, and a processor 24. The communication interface 21, the storage device 22, and the memory 23 are connected to the processor 24 via a signal line. The server 2 may further include an input device such as a keyboard/mouse, an output device such as a display, and the like. The server 2 may include a plurality of computers.

The communication interface 21 is capable of communicating with the plurality of vehicles 3, and enables the server 2 to communicate with the plurality of vehicles 3. Specifically, the communication interface 21 has an interface circuit for connecting the server 2 to the communication network 5. The server 2 communicates with the outside of the server 2 (for example, a plurality of vehicles 3) via the communication interface 21 and the communication network 5. The communication interface 21 is an example of a communication unit of the server 2.

The storage device 22 includes, for example, a hard disk drive (HDD), a solid state drive (SDD) or an optical recording medium, and an accessing device thereof. The storage device 22 stores various types of data, and stores, for example, map information, a computer program for the processor 24 to execute various processes, and the like. The storage device 22 is an example of a storage unit of the servers 2.

The memory 23 includes a non-volatile semiconductor memory (e.g., a RAM). The memory 23 temporarily stores, for example, various kinds of data used when various kinds of processing are executed by the processor 24. The memory 23 is another example of a storage unit of the server 2.

The processor 24 includes one or a plurality of CPU and peripheral circuitry thereof, and executes various processes. The processor 24 may further include other arithmetic circuits such as a logical arithmetic unit, a numerical arithmetic unit, or a graphic processing unit.

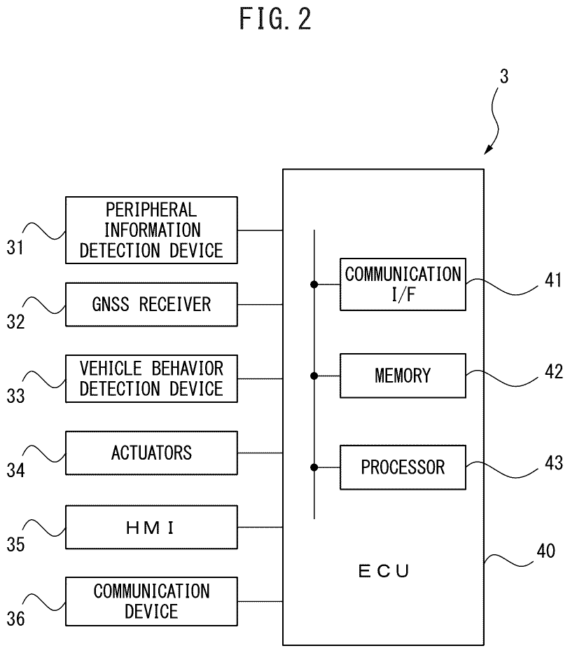

FIG. 2 is a diagram illustrating an exemplary configuration of the vehicle 3. The vehicle 3 comprises a peripheral information detection device 31, a GNSS receiver 32, a vehicle behavior detection device 33, actuators 34, a human-machine interface (HMI: Human Machine Interface) 35, a communication device 36 and an electronic control unit (ECU: Electronic Control Unit) 40. The peripheral information detection device 31, the GNSS receiver 32, the vehicle behavior detection device 33, the actuators 34, the HMI 35, and the communication device 36 are electrically connected to the ECU 40 via an in-vehicle network compliant with standards such as CAN (Controller Area Network).

The peripheral information detection device 31 acquires data (images, point cloud data, and the like) around the vehicle 3, and detects surrounding information (for example, a surrounding vehicle, a lane, a falling object, a pedestrian, an animal, a construction site, and the like) of the vehicle 3. For example, the peripheral information detection device 31 includes a camera, a millimeter-wave radar, a LIDAR (Laser Imaging Detection And Ranging), an ultrasonic sensor (sonar), and the like. The output of the peripheral information detection device 31, that is, the peripheral information of the vehicles 3 detected by the peripheral information detection device 31 is transmitted to the ECU 40.

The GNSS receiver 32 detects the present position of the vehicle 3 (for example, the latitude and longitude of the vehicle 3) based on positioning information obtained from a plurality of (for example, three or more) positioning satellites. Specifically, the GNSS receiver 32 captures a plurality of positioning satellites and receives radio waves transmitted from the positioning satellites. Then, the GNSS receiver 32 calculates the distance to the positioning satellite based on the difference between the transmission time and the reception time of the radio wave, and detects the present position of the vehicle 3 based on the distance to the positioning satellite and the position (orbit information) of the positioning satellite. The output of the GNSS receiver 32, i.e., the present position of the vehicles 3 detected by the GNSS receiver 32, is transmitted to the ECU 40. A GPS receiver is an example of the GNSS receiver.

The vehicle behavior detection device 33 detects a parameter indicating the behavior of the vehicle 3. The vehicle behavior detection device 33 includes, for example, a vehicle speed sensor that detects the speed of the vehicle 3, a yaw rate sensor that detects the yaw rate of the vehicle 3, and the like. The output of the vehicle behavior detection device 33, i.e., the parameters detected by the vehicle behavior detection device 33, is transmitted to the ECU 40.

The actuators 34 operate the vehicle. For example, the actuators 34 include a drive device for acceleration of the vehicle 3 (for example, at least one of an internal combustion engine and an electric motor), a brake actuator for braking the vehicle 3, a steering actuator for steering the vehicle 3, and the like. The ECU 40 controls the actuators 34 to control the behavior of the vehicles 3.

For example, the ECU 40 controls the actuators 34 to realize a predetermined driving support function. The predetermined driving assistance function includes, for example, an adaptive cruise control (ACC: Adaptive Cruise Control) that automatically controls the velocity of the vehicle 3 according to the presence or absence of the preceding vehicle, a lane keeping assist (LKA: Lane Keeping Assist) or a lane keeping assist (LTA: Lane Tracing Assist) that automatically controls the steering of the vehicle 3 so that the vehicle 3 is maintained in the lane, and the like.

The HMI 35 exchanges data between the vehicle 3 and an occupant (for example, a driver) of the vehicle 3. The HMI 35 includes an output unit (for example, a display, a speaker, a vibrating unit, and the like) that provides information to an occupant of the vehicle 3, and an input unit (for example, a touch panel, an operation button, an operation switch, a microphone, and the like) to which information is input by the occupant of the vehicle 3. The output of the ECU 40 is notified to the occupant of the vehicle 3 via the HMI 35, and the input from the occupant of the vehicle 3 is transmitted to the ECU 40 via the HMI 35. The HMI 35 is an example of an input device, an output device, or an input/output device. Note that the mobile terminals (smart phones, tablet terminals, and the like) of the occupants of the vehicles 3 may be connected to the ECU 40 so as to be able to communicate with each other by wire or wirelessly, and may function as the HMI 35.

The communication device 36 is capable of communicating with the outside of the vehicle 3, and enables communication between the vehicle 3 and the outside of the vehicle 3 (e.g., the servers 2). For example, the communication device 36 is a wide area radio communication device (e.g., a data communication module (DCM: Data Communication Module)) that enables wide area communication between the vehicle 3 and the outside of the vehicle 3.

The ECU 40 performs various controls of the vehicles. As shown in FIG. 2, the ECU 40 includes a communication interface 41, a memory 42, and a processor 43. The communication interface 41 and the memory 42 are connected to the processor 43 via signal lines. In the present embodiment, one ECU 40 is provided, but a plurality of ECU may be provided for each function.

The communication interface 41 has interface circuitry for connecting the ECU 40 to the in-vehicle networking. The ECU40 is connected to other in-vehicle equipments via the communication interface 41.

The memory 42 includes, for example, a volatile semiconductor memory and a non-volatile semiconductor memory. The memory 42 stores programs, data, and the like used when various kinds of processing are executed by the processor 43.

The processor 43 comprises one or more CPU (Central Processing Unit) and its peripheral circuitry. The processor 43 may further include an arithmetic circuit such as a logical arithmetic unit or a numerical arithmetic unit.

The configuration shown in FIG. 2 is merely an exemplary configuration of the vehicle 3. The plurality of vehicles 3 may have different configurations as long as they can communicate with the server 2.

Incidentally, in order to perform appropriate control in the vehicle 3, it is desirable that the traveling environment of the vehicle 3 is accurately grasped. However, when the general road and the automobile dedicated road are close to each other, it is difficult to determine which road the vehicle 3 is traveling on. In particular, this is noticeable when the vehicle 3 does not have map information.

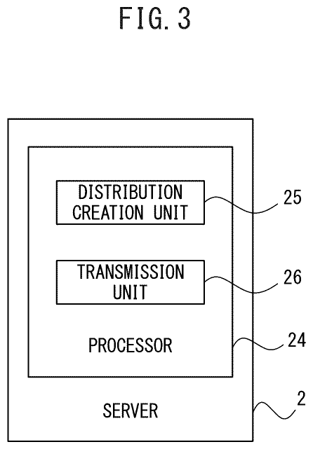

Therefore, in the present embodiment, the servers 2 function as an information providing device for providing information to the vehicle 3, and provide the vehicle 3 with information for identifying the type of the road on which the vehicle 3 is traveling. FIG. 3 is a functional diagram of the processor 24 of the server 2. In the present embodiment, the processor 24 includes a distribution creation unit 25 and a transmission unit 26. The distribution creation unit 25 and the transmission unit 26 are functional modules realized by the processor 24 of the server 2 executing a computer program stored in the storage device 22 of the server 2. Note that these functional modules may be realized by a dedicated arithmetic circuit provided in the processor 24.

The distribution creation unit 25 creates a distribution (hereinafter, referred to as “speed distribution”) of the vehicle speed corresponding to the traveling direction in each of the automobile dedicated road and the general road on each of the map tiles. The velocity distribution created by the distribution creation unit 25 is stored in the storage device 22 of the server 2. The transmission unit 26 transmits, to the target vehicle among the plurality of vehicles 3, information on the speed distribution of the map tile including the current position of the target vehicle. Thus, even if the target vehicle does not have the map information, the type of the road on which the target vehicle is traveling can be identified by using the speed distribution information. Therefore, it is possible to assist a vehicle having no map information in identifying a type of a road on which the vehicle is traveling.

In the present embodiment, the plurality of vehicles 3 includes a target vehicle (service beneficiary vehicle) that receives information from the server 2, and a probing vehicle that provides information to the server 2. For example, the distribution creation unit 25 creates a speed distribution based on data transmitted from the probing vehicle. This makes it possible to create a speed distribution that reflects real-time traffic conditions without requiring a special device to detect the vehicle speed on each of the automobile dedicated road and the general road.

Further, in the present embodiment, the probing vehicle detects an incident occurring on the road and transmits the position information of the incident to the server 2. The position information of the incident is stored in the storage device 22 of the server 2, and the transmission unit 26 transmits the position information of the incident to the target vehicle in addition to the information of the velocity distribution. This makes it possible to grasp the occurrence position of an incident on the road in the target vehicle, and thus to perform control for reducing the effect of the incident in the target vehicle.

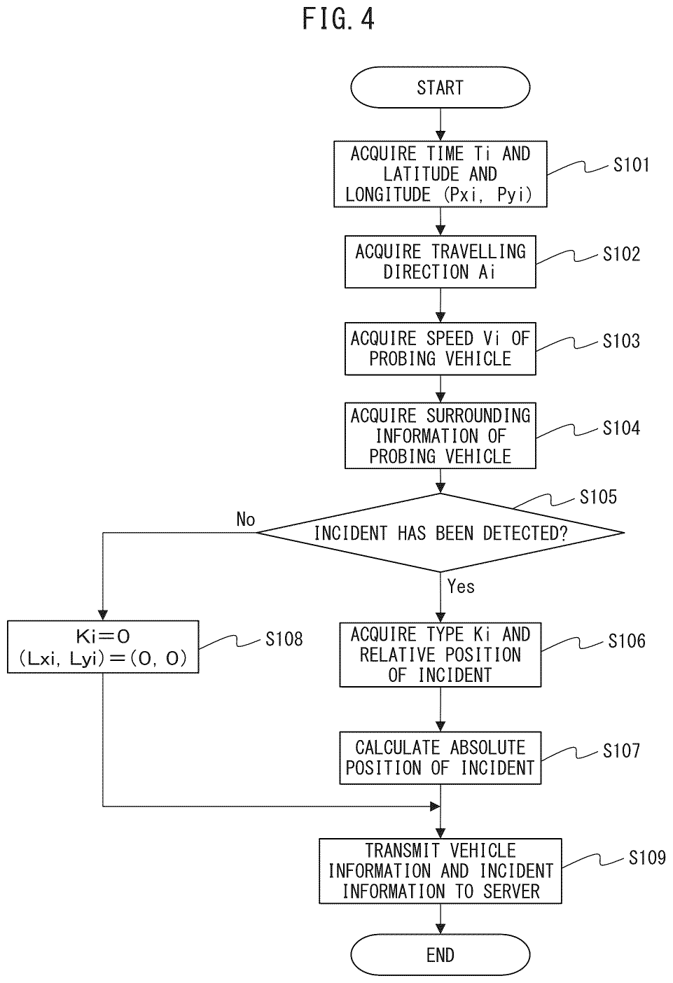

Hereinafter, a process flow executed in the probing vehicle, the server 2, and the target vehicle will be described with reference to FIG. 4 to FIG. 6. FIG. 4 is a flow chart showing a control routine executed in a probing vehicle. In each of the plurality of probing vehicles, the control routine is repeatedly executed by the processor 43 of the ECU 40 at predetermined runtime intervals.

First, in the step S101, the processor 43 acquires the time Ti and the latitude and longitude (Pxi, Pyi) of the probing vehicle (host vehicle). The latitude and longitude (Pxi, Pyi) of the probing vehicles are detected by GNSS receiver 32.

Then, in step S102, the processor 43 acquires the traveling direction Ai of the probing vehicle. For example, the processor 43 calculates the traveling direction Ai based on historical data of latitude and longitude (Pxi, Pyi).

Then, in step S103, the processor 43 obtains speed Vi of the probing vehicle. For example, the processor 43 calculates the speed Vi based on the output of the vehicle speed sensor of the vehicle behavior detecting device 33 or historical data of latitude and longitude (Pxi, Pyi).

Then, in the step S104, the processor 43 acquires surrounding information of the probing vehicle. The surrounding information is, for example, images acquired by a camera or point cloud data acquired by a millimeter-wave radar, and is detected by the peripheral information detection device 31.

Then, in the step S105, the processor 43 determines whether an incident has been detected on the roadway based on the surrounding information of the probing vehicle. Incidents are events that impede the passage of vehicles and include, for example, falling objects, construction sites, stoppages, animals, congestion, and the like. For example, the processor 43 detects an incident by analyzing the data acquired by the peripheral information detection device 31. In such data analysis, for example, a machine learning model such as a neural network, a support vector machine, or a random forest is used.

If it is determined in the step S105 that an incident has been detected, the control routine proceeds to step S106. In the step S106, the processor 43 obtains the type Ki of the incident and the relative position of the incident with respect to the probing vehicle. The type Ki of the incident is represented as a number corresponding to the type of the incident, and is outputted by, for example, a mechine-learning model for detecting the incident. The relative position of the incident is calculated, for example, based on the surrounding information of the probing vehicle, and is expressed as vehicle coordinates (Dxi, Dyi) with respect to the probing vehicle.

Next, in the step S107, the processor 43 calculates the absolute position of the incident based on the relative position of the incident, the latitude and longitude (Pxi, Pyi) of the probing vehicle, and the travel direction Ai of the probing vehicle. The absolute position of the incident is calculated, for example, as a world coordinate (Lxi, Lyi) with a predetermined position as an origin.

On the other hand, if it is determined in the step S105 that an incident has not been detected, the present control routine proceeds to step S108. In the step S108, the processor 43 enters zeros as the type Ki of the incident and world coordinates (Lxi, Lyi). Zero indicates that there is no incident.

After the step S107 or the step S108, the control routine proceeds to step $109. In the step S109, the processor 43 transmits the vehicle information and the incident information to the servers 2. Specifically, the processor 43 transmits, as the vehicle information, the identification information IDi of the probing vehicle, the time Ti, the latitude and longitude (Pxi, Pyi) of the probing vehicle, the traveling direction Ai of the probing vehicle, and the velocity Vi of the probing vehicle to the server 2, and transmits, as the incident information, the type Ki of the incident and the world coordinates (Lxi, Lyi) to the server 2. After the step S109, the control routine ends.

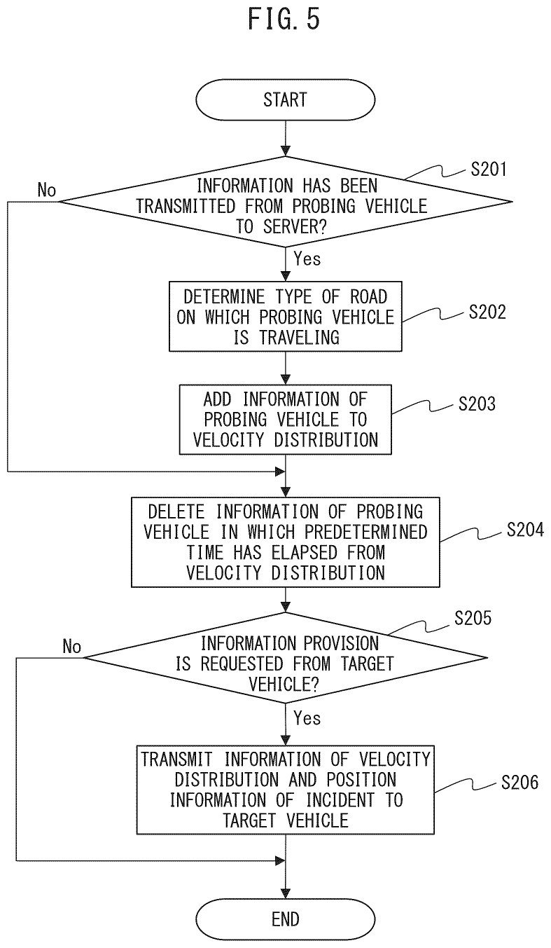

FIG. 5 is a flow chart showing a control routine executed in the server. This control routine is repeatedly executed by the processor 24 of the server 2 at predetermined execution intervals.

First, in the step S201, the distribution creation unit 25 of the processor 24 determines whether or not information (vehicle information and incident information) has been transmitted from the probing vehicle to the server 2. If it is determined that the probing vehicle has transmitted the information to the server 2, the present control routine proceeds to step S202.

In the step S202, the distribution creation unit 25 determines the type of the road on which the probing vehicle is traveling (a general road or an automobile dedicated road) based on the history data of the latitude and longitude (Pxi, Pyi) of the probing vehicle and the map information stored in the storage device 22. For example, the distribution creation unit 25 determines the type of the road by using a known map matching method. The type information of the road on which the probing vehicle is traveling is associated with the information transmitted from the probing vehicle to the server 2, and the information is stored in the storage device 22 or the memory 23 of the server 2.

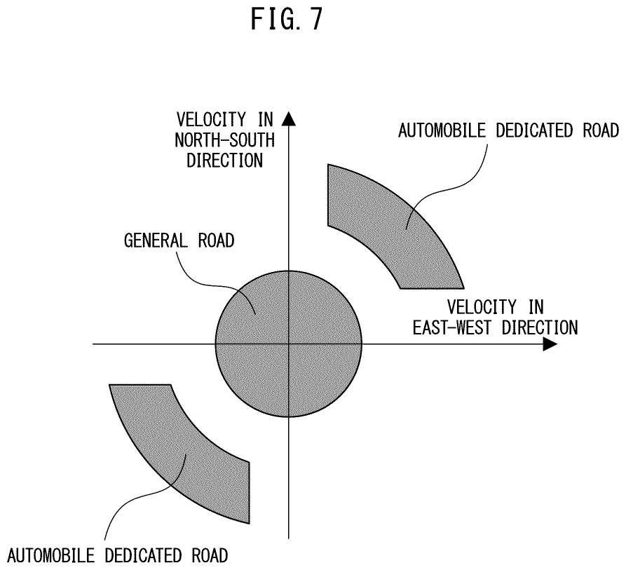

Next, in the step S203, the distribution creation unit 25 adds the information of the probing vehicle that have transmitted the information to the server 2 to the velocity distribution. FIG. 7 is a diagram illustrating an example of the velocity distribution. The velocity distribution is created for each map tile, and indicates the vehicle velocity on each of the automobile dedicated road and the general road. A map tile is a map divided into tiles, and is also commonly referred to as a regional mesh. The map tile is typically displayed as an image of 256 pixels by 256 pixels. A map tile containing the current position of the probing vehicle is identified based on the latitude and longitude of the probing vehicle, and information of the probing vehicle is added to the velocity distribution for the identified map tile. If the probing vehicle is traveling on a general road, the speed of the probing vehicle is added as a speed relating to the general road, while if the probing vehicle is traveling on an automobile dedicated road, the speed of the probing vehicle is added as a speed relating to the automobile dedicated road.

After the step S203, the control routine proceeds to step S204. On the other hand, if it is determined in the step S201 that no information has been transmitted from the probing vehicle to the server 2, the control routine skips the steps S202 and S203 and proceeds to the step S204. In the step S204, the distribution creation unit 25 deletes the information of the probing vehicle in which a predetermined time has elapsed from the time (time Ti) at which the information was acquired, from the velocity distribution, in order to delete the old information from the velocity distribution.

Next, in the step S205, the transmission unit 26 of the processor 24 determines whether or not the information provision is requested from the target vehicle. When it is determined that the information provision is not requested from the target vehicle, the present control routine ends. On the other hand, if it is determined that the information provision is requested from the target vehicle, the present control routine proceeds to step S206.

In the step S206, the transmission unit 26 transmits, to the target vehicle, the map tile including the present position of the target vehicle, that is, the information of the velocity distribution and the position information of the incident for the map tile in which the target vehicle is present. After the step S206, the control routine ends.

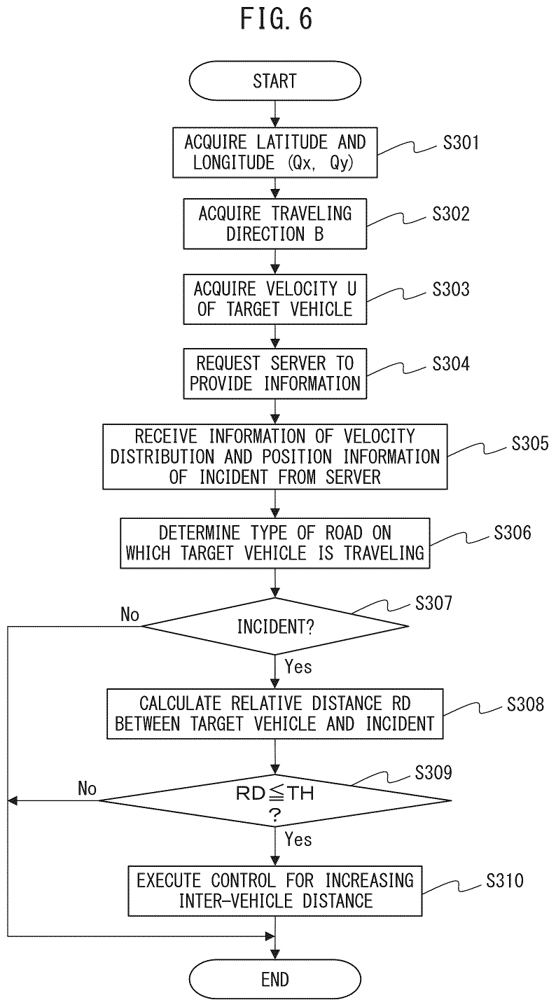

FIG. 6 is a flow chart showing a control routine executed in a target vehicle. In each of the plurality of target vehicles, the control routine is repeatedly executed by the processor 43 of the ECU 40 at predetermined runtime intervals.

First, in the step S301, the processor 43 acquires the latitude and longitude (Qx, Qy) of the target vehicle (host vehicle). The latitude and longitude (Qx, Qy) of the target vehicle are detected by the GNSS receiver 32.

Next, in step S302, the processor 43 acquires the traveling direction Bi of the target vehicle. For example, the processor 43 calculates the traveling direction B based on the historical data of latitude and longitude (Qx, Qy).

Then, in step S303, the processor 43 acquires the velocity U of the target vehicle. For example, the processor 43 calculates the velocity U based on the output of the vehicle speed sensor of the vehicle behavior detecting device 33 or historical data of latitude and longitude (Qx, Qy).

Then, in the step S304, the processor 43 requests the server 2 to provide information by transmitting the latitude and longitude (Qx, Qy) of the target vehicle to the server 2. Consequently, the server 2 transmits the information to the target vehicle, and in the step S305, the processor 43 receives the information of the velocity distribution and the position information of the incident from the server 2.

Next, in the step S306, the processor 43 determines the type of the road on which the target vehicle is traveling (the general road or the automobile dedicated road) on the basis of the velocity information transmitted from the servers 2 to the target vehicle. Specifically, the processor 43 determines the type of the road by checking the traveling direction B and the velocity U of the target vehicle with the vehicle speed corresponding to the traveling direction in the velocity distribution. When the traveling direction B and the velocity U of the target vehicle are similar to the data regarding the general road, it is determined that the target vehicle is traveling on the general road, while when the traveling direction B and the velocity U of the target vehicle are similar to the data regarding the automobile dedicated road, it is determined that the target vehicle is traveling on the automobile dedicated road.

Next, in the step S307, the processor 43 determines whether there is an incident on the travel route of the target vehicle based on the position information of the incident transmitted from the servers 2 to the target vehicle. When the type of the road on which the incident exists and the type of the road on which the target vehicle is traveling are the same and the incident is located in front of the target vehicle, it is determined that an incident exists on the travel route of the target vehicle.

If it is determined in the step S307 that there is no incident, the present control routine ends. On the other hand, if it is determined in the step S307 that an incident exists, the present control routine proceeds to step S308. In the step S308, the processor 43 calculates a relative distance RD between the target vehicle and the incident. For example, the processor 43 converts the latitude and longitude (Qx, Qy) of the target vehicle into world coordinates, and calculates the relative distance RD based on the world coordinates of the target vehicle and the incident.

Then, in the step S309, the processor 43 determines whether the relative distance RD is equal to or less than a predetermined threshold TH. If it is determined that the relative distance RD is greater than the threshold TH, the present control routine ends. On the other hand, if it is determined that the relative distance RD is less than or equal to the threshold TH, the present control routine proceeds to step S310.

In the step S310, the processor 43 executes control for increasing the inter-vehicle distance between the target vehicle and the preceding vehicle. For example, when ACC is operated in the target vehicle, the processor 43 increases the set inter-vehicle distance in ACC. Further, the processor 43 may propose to the driver of the target vehicle to increase the inter-vehicle distance between the target vehicle and the preceding vehicle via the HMI 35. After the step S310, the control routine ends.

In the step S310, the processor 43 may execute control for avoiding an incident. Here, for example, the processor 43 proposes, via the HMI 35, the driver of the target vehicle to move to a lane other than the lane in which the incident exists (change the lane to another lane).

Between the step S205 and the step S206 of FIG. 5, the transmission unit 26 may determine whether or not the target vehicle requesting the provision of information is located on the map tile in which the incident is occurring. If the determination is negative, the control routine ends, while if the determination is affirmative, the control routine proceeds to step S206. That is, the transmission unit 26 may identify the target vehicle located on the map tile in which the incident is occurring, and transmit the information of the distribution and the position information of the incident to the identified target vehicle. Accordingly, when the necessity of providing the information to the target vehicle is low, the information is not transmitted from the server 2 to the target vehicle, and thus the communication load can be reduced.

While preferred embodiments of the present disclosure have been described above, the present disclosure is not limited to these embodiments, and various modifications and changes can be made within the scope of the claims. For example, the position information of the incident may be omitted from the information transmitted from the transmission unit 26 to the target vehicle. In addition, one vehicle 3 may serve as a probing vehicle and a target vehicle.

In addition, the distribution creation unit 25 may create a velocity distribution based on data transmitted from a vehicle speed sensor (for example, an automated speed violating device) provided on a road or the like, instead of the data transmitted from the probing vehicle. The velocity distribution which is generated by the operator or the like and the position information of the incident which is inputted by the operator or the like may be stored in the storage device 22 of the server 2. In this case, the distribution creation unit 25 is omitted.

Further, the vehicle 3 may be a manual driving vehicle having no driving support function, or an autonomous driving vehicle in which all of acceleration, steering, and deceleration (braking) of the vehicle 3 are automatically executed. In addition, a computer program that causes a computer to realize the functions of the respective units included in the processor 24 of the server 2 may be provided in a form stored in a computer-readable recording medium. The computer-readable recording medium is, for example, a magnetic recording medium, an optical recording medium, or a semiconductor memory.

### REFERENCE SIGNS LIST

2 Server
21 Communication interface
22 Storage device
23 Memory
24 Processor
26 Transmission unit
3 Vehicle

1. An information providing device comprising:
a communication unit capable of communicating with a plurality of vehicles;
a storage unit configured to store a distribution of vehicle speeds corresponding to a traveling direction in each of an automobile dedicated road and a general road on each of map tiles; and
a processor configured to transmit, to a target vehicle among the plurality of vehicles, information of the distribution for a map tile including a current position of the target vehicle.

2. The information providing device according to claim 1, wherein the processor is configured to create the distribution based on data transmitted from a probing vehicle among the plurality of vehicles.

3. The information providing device according to claim 1, wherein
the storage unit is configured to store position information of an incident that has occurred on a road, and
the processor is configured to transmit the position information of the incident to the target vehicle in addition to the information of the distribution.

4. The information providing device according to claim 3, wherein the processor is configured to identify a target vehicle located on a map tile in which the incident has occurred, and transmit the information of the distribution and the position information of the incident to the target vehicle.

5. A method of providing information, comprising:
storing a distribution of vehicle speeds corresponding to a travel direction in each of an automobile dedicated road and a general road on each of map tiles; and
transmitting, to a target vehicle, information of the distribution for a map tile including a current position of the target vehicle.
